(19) United States
(12) Patent Application Publication
(10) Pub. No.: US 2012/0207207 A1
(43) Pub. Date: Aug. 16, 2012

(54) Method, system and associated modules for transmission of complimenting frames

(76) Inventors: Ofer Peer, Herzliya (IL); Zvi Reznic, Tel Aviv (IL)

(21) Appl. No.: 12/929,714

(22) Filed: Feb. 10, 2011

(51) Int. Cl. H04N 7/26

(52) U.S. Cl. 375/240.01; 375/E07.026

(57) ABSTRACT

Disclosed are methods, circuits, devices and systems for transmission of two visually complimenting video frames (e.g. left-eye frame data and right-eye frame data) of a three dimensional video stream. A set of visually complimenting video frames intended to make a substantially three dimensional image may be referred to as a three dimensional impression set. A video signal/stream in a first (e.g. 3D) format may be processed for transmission over a wireless link, wherein processing may include generating one or more transmission frames including data for at least two complimenting video frames. The data for both complimenting video frames is uncompressed.

### FIELD OF THE INVENTION

The present invention relates generally to the field of wireless communication. More specifically, the present invention relates to methods, systems and associated modules and software components for transmission of complimenting frames.

### BACKGROUND

Wireless communication has rapidly evolved over the past decades. Even today, when high performance and high bandwidth wireless communication equipment is made available there is demand for even higher performance at a higher data rates, which may be required by more demanding applications.

Video signals may be generated by various video sources, for example, a computer, a game console, a Video Cassette Recorder (VCR), a Digital-Versatile-Disc (DVD), a Blu-ray (BR) disk player, or any other suitable video source. In many houses, for example, video signals are received through cable or satellite links at a Set-Top Box (STB) located at a fixed point.

In many cases, it may be desired to place a screen or projector at a location in a distance of at least a few meters from the video source. This trend is becoming more common as flat-screen displays, e.g., plasma or Liquid Crystal Display (LCD) televisions are hung on a wall. Connection of such a display or projector to the video source through cables is generally undesired for aesthetic reasons and/or installation convenience. Thus, wireless transmission of the video signals from the video source to the screen is preferred.

WHDI—Wireless Home Digital Interface is a new standard for wireless high-definition video connectivity between a video source (e.g. cable box) and video sink (e.g. display). It provides a high-quality, uncompressed wireless link which can support delivery of equivalent video data rates of up to 3 Gbit/s (including uncompressed 1080p) in a 40 MHz channel within the 5 GHz unlicensed band. Equivalent video data rates of up to 1.5 Gbit/s (including uncompressed 1080i and 720p) can be delivered on a single 20 MHz channel in the 5 GHz unlicensed band, conforming to worldwide 5 GHz spectrum regulations. Range is beyond 100 feet (30 m), through walls, and latency is less than one millisecond.

The WHDI standard is partially based on transmission of uncompressed video, such that each video frame is transmitted as a complete renderable video frame data set. In order to achieve the high data rates required for such transmission, WHDI utilizes analog (non-discrete) transmission symbol encoding and decoding. To date, such analog transmission encoding/decoding has not been suitable for transmission of three dimension (3D) video. For 3D video, two complimenting video frames are needed to deliver a substantially real-time 3D image, necessitating faster and more efficient video data transmission rates.

There is thus a need in the field of wireless communication for improved methods, systems and associated modules and software components for transmission of complimenting frames.

### SUMMARY OF THE INVENTION

The present invention includes methods, circuits, devices and systems for transmission of two visually complimenting video frames (e.g. left-eye frame data and right-eye frame data) of a three dimensional video stream. A set of visually complimenting video frames intended to make a substantially three dimensional image may be referred to as a three dimensional impression set. According to some embodiments, a video signal/stream in a first (e.g. 3D) format may be processed for transmission over a wireless link, wherein processing may include generating one or more transmission frames including data for at least two complimenting video frames. According to further embodiments of the present invention, the data for both complimenting video frames is uncompressed.

According to some embodiments of the present invention, data from at least two visually complimenting video frames of a single three dimensional impression set may be combined into a single video transmission frame. According to further embodiments of the present invention, the three dimensional impression set may be formatted as an active frame, wherein the active frame may include left and right eye frame data separated by an interlude. Processing for transmission over a single transmission frame may include reduction, removal and/or transposition of the interlude.

According to further embodiments of the present invention, processing for transmission may include transposition of portions of left and right frame data into a single transmission frame, such that the left and right frame data is combined into the frame in an interlaced pattern. The interlaced pattern may be in the form of stripes, lines, checkerboard pattern or other.

According to further embodiments of the present invention, there may be provided processing control circuits and/or logic adapted to identify a format of the input video signal/stream. Identification may include determining: (1) whether the video signal/stream has complimenting video frames, (2) formatting of the complimenting video frame data, and (3) any other parameters relevant for transmission processing of the video signal/stream. The processing control circuits/logic may be adapted to convert the input video signal/stream into one or a set of transmission frames, wherein the conversion process is at least partially based on a detected format of the input signal/stream. According to some embodiments of the present invention, the processing control circuit/logic may convert the input signal/stream into a dataset in an intermediate format. The dataset in the intermediate format may be used, either by the processing control circuit/logic or by a functionally associated circuit/logic, to generate a transmission frame. According to yet further embodiments of the present invention, either the processing control circuit/logic or a functionally associated circuit/logic may select a format for the transmission frame, wherein selection of the transmission frame format may be at least partially based on: (1) one or more parameters of the transmission link, (2) capabilities of the video sink device, (3) capabilities of the video sink-side transceiver, and/or (4) the format of the input video signal/stream.

According to some embodiments of the present invention, data from at least two visually complimenting video frames of a single three dimensional impression set may be separated into two video transmission frames. According to further embodiments of the present invention, the three dimensional impression set may be formatted as an active frame, wherein the active frame may include left and right eye frame data separated by an interlude (e.g. an active space). Processing for transmission over two transmission frames may include reduction, removal and/or transposition of the active space.

According to some embodiments of the present invention, there may be provided processing control circuits and/or logic adapted to identify a format of the three dimensional impression set. The processing control circuits/logic may be adapted to convert the input video signal/stream into a set of transmission frames, wherein the conversion process is at least partially based on a detected format of the input signal/stream. According to some embodiments of the present invention, the processing control circuit/logic may convert the input signal/stream into a dataset in an intermediate format. The dataset in the intermediate format may be used, either by the processing control circuit/logic or by a functionally associated circuit/logic, to generate transmission frames. According to yet further embodiments of the present invention, either the processing control circuit/logic or a functionally associated circuit/logic may select a format for the transmission frame, wherein selection of the transmission frame format may be at least partially based on the format of the input video signal/stream. According to further embodiments of the present invention, processing for transmission may include transposition of portions of left and right frame data into two transmission frames, such that the left and right frame data is separated from some original interlaced pattern.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are functional block diagrams of exemplary video source transceiver and video sink transceiver arrangements according to some embodiments of the present invention where the video source transceiver includes a video transmission circuit and the video sink transceiver includes a video reception circuit;

FIGS. 2A and 2B are functional block diagrams of exemplary video source transceivers according to some embodiments of the present invention where the source transceivers includes image processing components;

FIGS. 3A and 3B are schematic diagrams showing examples of complimentary frame combinations according to some embodiments of the present invention; and

FIGS. 4A and 4B are schematic diagrams including the steps of exemplary methods by which a source transceiver may process complimenting video frames with associated data according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, portable media players, cell phones, mobile devices, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

Some demonstrative embodiments may be implemented to communicate wireless-video signals over a wireless-video communication link, as well as Wireless-Local-Area-Network (WLAN) signals over a WLAN link. Such implementation may allow a user, for example, to play a movie, e.g., on a laptop computer, and to wirelessly transmit video signals corresponding to the movie to a video destination, e.g., a screen, while maintaining a WLAN connection, e.g., with the Internet and/or one or more other devices connected to a WLAN network. In one example, video information corresponding to the movie may be received over the WLAN network, e.g., from the Internet.

According to some embodiments of the present invention, there may be a transmitter comprising video signal/stream processing logic adapted to combine data from at least two visually complimenting video frames of a single three dimensional impression set into a single video transmission frame. According to further embodiments of the present invention, the video signal/stream processing logic may be further adapted to determine a first format of a received video signal/stream including at least two visually complimenting frames of a single three dimensional impression set.

According to some embodiments of the present invention, the video signal/stream processing logic may be further adapted to select a second format for a transmission frame, wherein selection may at least be partially based on a parameter selected from the group consisting of transmission link quality, capabilities of a video sink device, capabilities of a video sink-side transceiver, and format of the input video signal/stream. According to some embodiments of the present invention, the second format for a transmission frame may be selected from the group consisting of a horizontal stripe partition, a checkerboard arrangement, a vertical stripe partition, and a division of the frames.

According to some embodiments of the present invention, the transmitter may be further adapted to transmit the single video transmission frame to a functionally associated receiver. According to further embodiments of the present invention, the transmitter may be further adapted to be an OFDM transmitter.

According to some embodiments of the present invention, there may be a transmitter comprising video signal/stream processing logic adapted to determine a first format of a received video signal/stream including at least two visually complimenting frames of a single three dimensional impression set. According to further embodiments of the present invention, the video signal/stream processing logic may be further adapted to select a second format for a transmission frame, wherein selection is at least partially based on a parameter selected from the group consisting of transmission link quality, capabilities of a video sink device, capabilities of a video sink-side transceiver, and format of the input video signal/stream.

According to some embodiments of the present invention, the second format for a transmission frame may be selected from the group consisting of a horizontal stripe partition, a checkerboard arrangement, a vertical stripe partition, and a division of the frames. According to further embodiments of the present invention, the video signal/stream processing logic may be further adapted to combine data from at least two visually complimenting video frames of a single three dimensional impression set into a single video transmission frame.

According to some embodiments of the present invention, the transmitter may be further adapted to transmit the single video transmission frame to a functionally associated receiver. According to further embodiments of the present invention, the transmitter may be further adapted to be an OFDM transmitter.

According to some embodiments of the present invention, there may be a transmitter comprising video signal/stream processing logic adapted to separate data from at least two visually complimenting video frames of a single three dimensional impression set into two video transmission frames. According to further embodiments of the present invention, the transmitter may further comprise a format resolver adapted to determine a format of the three dimensional impression set. According to further embodiments of the present invention, the determined format of the three dimensional impression set may be from the group consisting of a horizontal stripe partition, a checkerboard arrangement, a vertical stripe partition, and a division of the frames. According to further embodiments of the present invention, the format resolver may be further adapted to determine a location of an interlude situated between the visually complimenting video frames. The transmitter may be further adapted to remove and/or relocate the interlude.

According to some embodiments of the present invention, the transmitter may be further adapted to transmit the two video transmission frames to a functionally associated receiver. According to further embodiments of the present invention, the transmitter may be further adapted to be an OFDM transmitter.

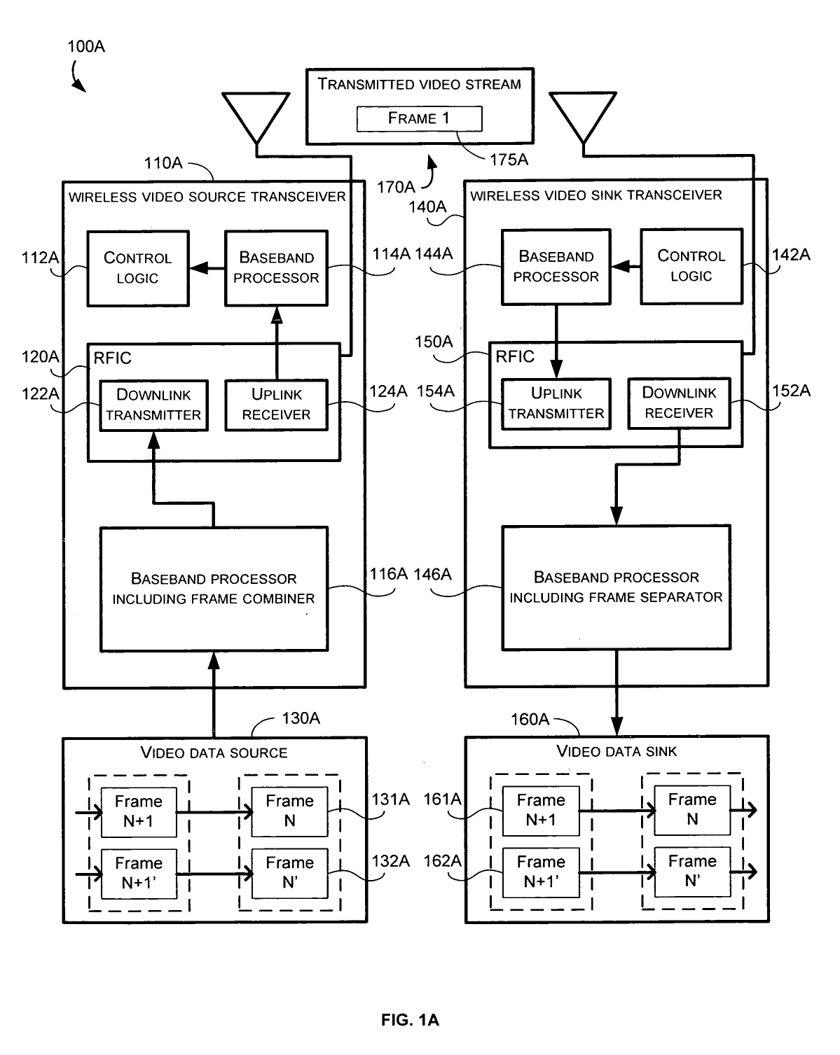

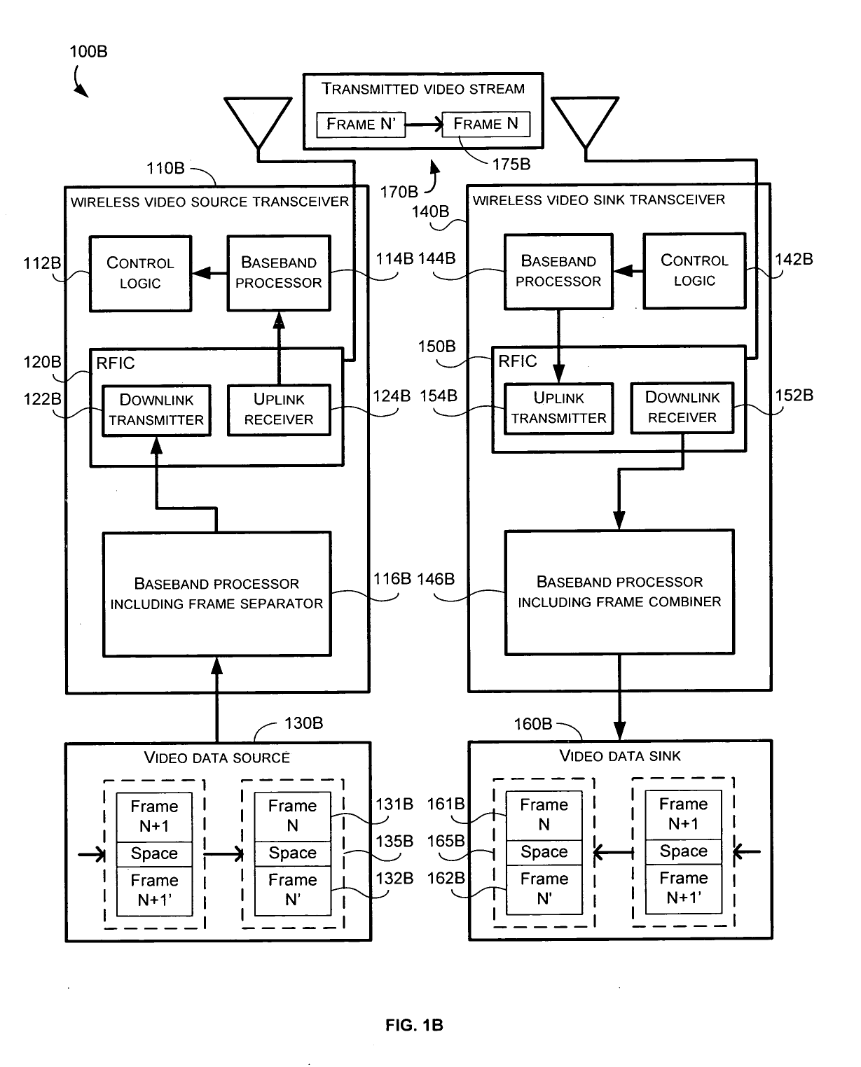

Now turning to FIGS. 1A and 1B, there are shown functional block diagrams of exemplary video source transceiver and video sink transceiver arrangements according to some embodiments of the present invention where the video source transceiver includes a video transmission circuit and the video sink transceiver includes a video reception circuit. There is shown an example of the system in accordance with some aspects of the invention, such as system 100A. System 100A may be used to transmit and receive complimenting frames. System 100A, may comprise an input video stream such as video data source 130A. Video data source 130A may further be comprised of a video data stream or signal and may be any type of video data stream such as analog, digital, interlaced or progressive. Video data source 130A may comprise frames such as Frame N and Frame N′ as depicted by elements 131A and 132A accordingly in FIG. 1A. Frame N and Frame N′ may be visually complimenting video frames of a three dimensional impression set, for example, Frame N may be associated with a right eye view while Frame N′ is associated with a left eye view, Frame N may be associated with a view at a certain point in time while Frame N′ is the same view at a delayed point of time, or Frame N may be associated with a first color layer while frame N′ is a second color layer.

Video data source 130A may be fed, transmitted, inserted, input to a wireless video source transceiver, such as wireless video source transceiver 110A, which is also included in system 100A. Optionally, additional information may also be input to wireless video source transceiver 110A such as the format of the input video signal. Video data source 130A may be associated or compliant with 3D, 4D, HD3D and additional formats with complimenting video frames.

According to some embodiments of the present invention wireless video source transceiver 110A may include radio-frequency integrated chip (RFIC) 120A to transmit and receive data signals along a functionally associated antenna. According to further embodiments of the present invention, the RFIC may include downlink transmitter 122A for transmitting downlink data signals and uplink receiver 124A for receiving uplink data signals. According to further embodiments of the present invention, wireless video source transceiver 110A may include a processing logic module such as baseband processor 116A.

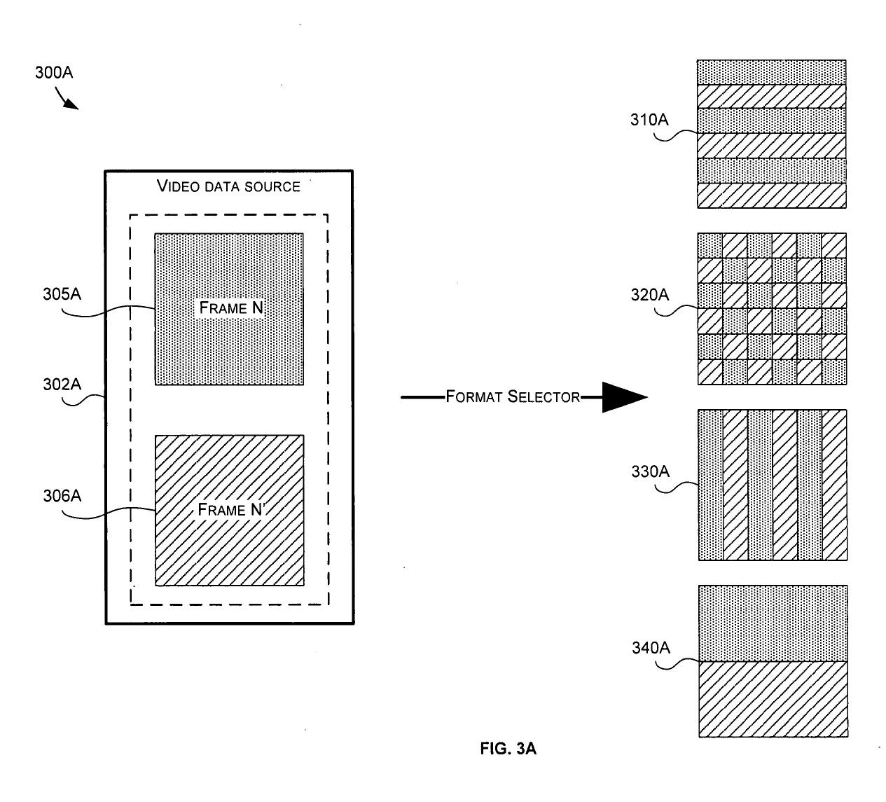

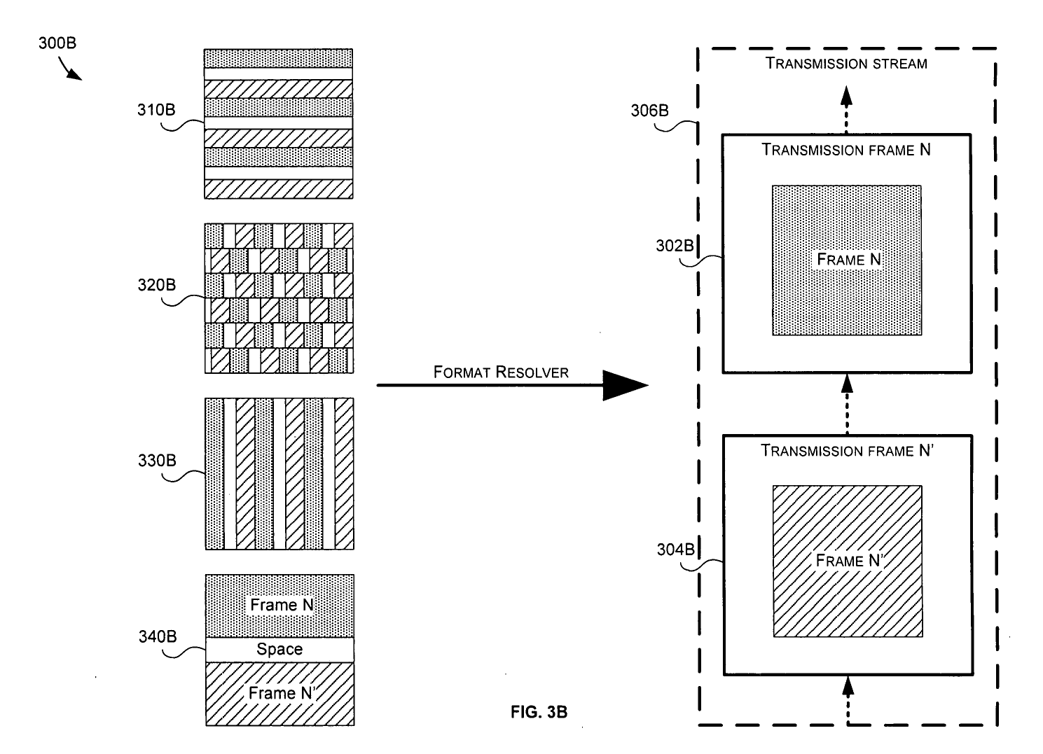

Baseband processor 116A may receive video data from video data source 130A and combine data from at least two visually complimenting video frames of a three dimensional impression set, such as Frame N and Frame N′, into a single transmission frame. Combining data is understood to be defined as manipulating the separate data into a single frame, some examples include: removing an interlude from two associated frames, interleaving frames and more. Additional examples can be found as described in FIG. 3A.

Baseband processor 116A may then transfer the data to downlink transmitter 122A which may transmit the data via the functionally associated antenna, resultant in which a transmitted video stream, such as transmitted video stream 170A is transmitted. It is understood that, for example, transmitted video stream 170A may include a frame such as FRAME 1 (175A) which may be a transmission frame associated with visually complimenting video frames of a three dimensional impression set: Frame N and Frame N′.

According to some embodiments of the present invention, wireless video sink transceiver 140A may include RFIC chip 150A to transmit and receive data signals along a functionally associated antenna. According to further embodiments of the present invention, the RFIC may include downlink receiver 152A for receiving combined video data signals.

According to some embodiments of the present invention, wireless video sink transceiver 140A may include baseband processor 146A to take combined video data signals received, via downlink receiver 152A, from video source transceiver 110A and process the data for functionally associated video data sink 160A.

There is shown an example of the system in accordance with some aspects of the invention, such as system 100B. According to some embodiments of the present invention, Wireless video source transceiver 110B may include Baseband processor 116B to receive video data from Video data source 130B and separate data from at least two visually complimenting video frames of a three dimensional impression set (135B), such as Frame N and Frame N′, into two transmission frames. Separating data is understood to be defined as extracting the separate data frames (i.e. 131B and 132B) from the single impression set (i.e. 135B).

According to some embodiments of the present invention, Wireless video sink transceiver 140B may include baseband processor 146B to take separated video data signals received, via downlink receiver 152B, from video source transceiver 1108 and process the data for functionally associated video data sink 160B. Processing the received data is understood to be defined as combining the received data frames (i.e. 161B and 162B) into a single impression set (i.e. 165B) e.g. by inserting an interlude in between the frames.

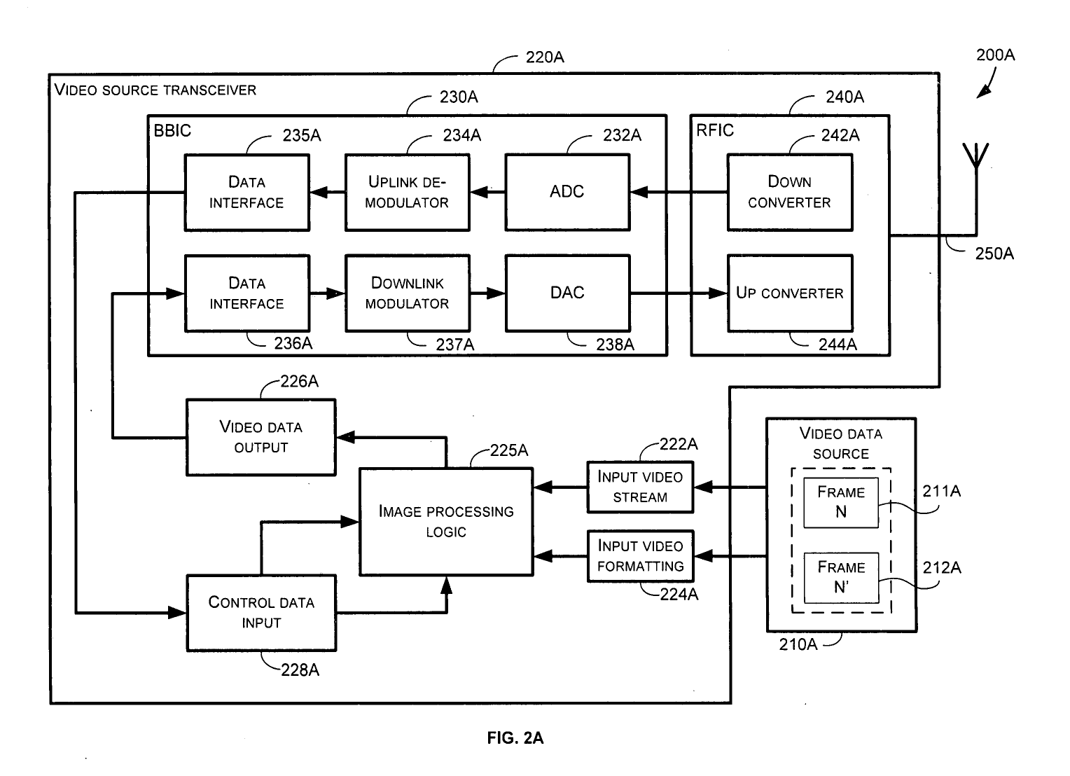

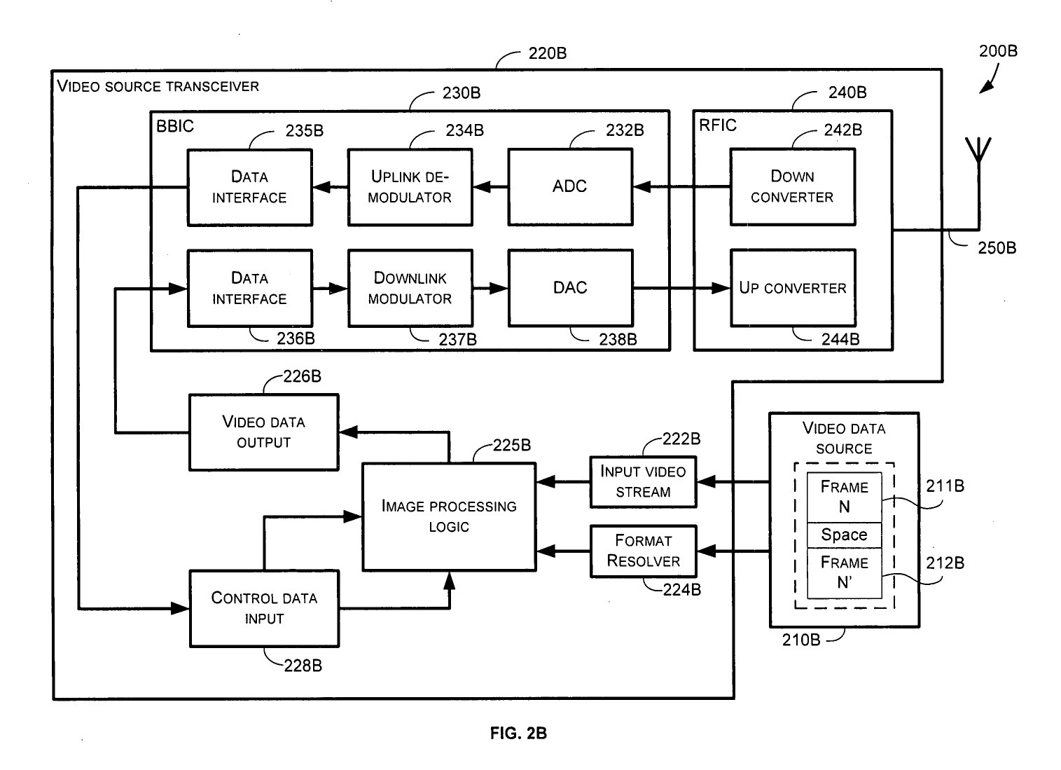

Turning now to FIGS. 2A and 2B, there are shown functional block diagrams of exemplary video source transceivers according to some embodiments of the present invention where the source transceivers includes image processing components. There is shown an example of the system in accordance with some aspects of the invention, such as system 200A. System 200A may be used to transmit complimenting frames.

It is understood that elements 220A, 210A, 211A, 212A, 240A, 242A and 244A of FIG. 2A are substantially the same as elements 110A, 130A, 131A, 132A, 120A, 124A and 122A of FIG. 1A; respectively.

System 200A further comprises a source side transceiver such as source side transceiver 220A, which may receive an input video stream and additional data such as format of the input video stream, video sink device capabilities, transmission link quality and/or additional data and subsequently transmit a video stream associated with the input video stream via an antenna such as antenna 250A.

Source side transceiver 220A may include a downlink transmitter, such as up converter 244A, which is understood to be functionally similar to transmitter 122A described in relation to FIG. 1A. Source side transceiver 220A may include an uplink receiver, such as down converter 242A, which may receive input/information/data via antenna 250A and transfer signals or information to a processing logic module, such as image processing logic 225A via control data input 228A. The signals transferred from control data input 228A to image processing logic 225A may be associated with the video sink device capabilities, transmission link quality or otherwise.

Image processing logic 225A may receive input video stream 222A and combine data from at least two visually complimenting video frames of a three dimensional impression set, such as Frame N and Frame N′, into a single transmission frame. Combining data is understood to be defined as manipulating the separate data into a single frame, some examples include: removing an interlude from two associated frames, interleaving frames and more. Additional examples can be found as described in FIG. 3A. According to some embodiments, image processing logic 225A may determine which conversion, adaptation, translation or alteration to implement or carry out based on any one, or a combination of optional inputs such as: format of the input video signal (i.e. via input video formatting 224A), video device sink capabilities, transmission link quality, and parameters associated with the received input video signal or other.

There is shown an example of the system in accordance with some aspects of the invention, such as system 200B. System 200B may be used to transmit complimenting frames.

According to some embodiments of the present invention, system 200B may include Image processing logic 225B to receive input video stream 222B and separate data from two visually complimenting video frames of a three dimensional impression set, such as Frame N and Frame N′, into two transmission frames. Separating data is understood to be defined as manipulating the data frames into two separate frames, some examples include: removing an interlude from two associated frames, de-interleaving frames and more. Additional examples can be found as described in FIG. 3B. According to some embodiments, image processing logic 225B may determine which conversion, adaptation, translation or alteration to implement or carry out based on any one, or a combination of optional inputs such as: format of the input video signal (i.e. via format resolver 224B), video device sink capabilities, transmission link quality, and parameters associated with the received input video signal or otherwise.

Turning now to FIG. 3A, there is shown a schematic diagram showing examples of complimentary frame combinations according to some embodiments of the present invention. Manipulation diagram 300A depicts several examples of optional manipulations from visually complimenting video frames of a three dimensional impression set into a single output video frame in accordance with some embodiments of the invention. It is understood that video data source 302A and Frame N (305A) and Frame N′ (306A) are substantially identical to video data source 130A and Frame N and N′ (131A and 132A) of FIG. 1A. Exemplary output frames associated with an output of the processing logic module or a subsequent transmitted video stream may be a horizontal stripe partition such as depicted by frame 310A; a checkerboard arrangement such as depicted by frame 320A; a vertical stripe partition such as depicted by frame 330A; and a division of the frames such as depicted by frame 340A. In the exemplary frames 310A, 320A, 330A and 340A it is understood that a group (for example dotted) correlates to one of the Input Video stream frames (for example Frame N (305A)).

According to some embodiments a processing logic module such as image processing logic 225A may manipulate an input into one of a group of outputs based on additional parameters. For example, different input formats may be manipulated into different output video frames.

Now turning to FIG. 3B, there is shown a schematic diagram showing examples of complimentary frame combinations according to some embodiments of the present invention. According to some embodiments of the present invention, formatting diagram 300B depicts several examples of possible combinations of visually complimenting video frames of a three dimensional impression set within a single input video frame in accordance with some embodiments of the invention. It is understood that Transmission stream 306B, including Transmission frame N (302B) and Transmission frame N′ (304B), are substantially identical to transmitted video stream 175B, including Frame N and Frame N′ of FIG. 1B.

According to some embodiments of the present invention, exemplary input frames associated with an input from a video data source may be a horizontal stripe partition such as depicted by frame 310B; a checkerboard arrangement such as depicted by frame 320B; a vertical stripe partition such as depicted by frame 330B; and a division of the frames such as depicted by frame 340B. In the exemplary frames 310B, 320B, 330B and 340B it is understood that a group (for example dotted) correlates to one of the video data frames (for example Frame N (302B)). A white group may represent a space allotted to an input frame as a buffer between video frames within each input frame.

According to some embodiments of the present invention, a format resolver may determine a format of an input video frame including a determination of the space allotment. According to further embodiments of the present invention, the input video frame may be separated into two data frames for transmission (i.e. transmission frame N (302B) and transmission frame N′ (304B)) using the determined formatting. Separation may include removing the space allotment and/or moving the space allotment to a different portion of the transmitted video frame.

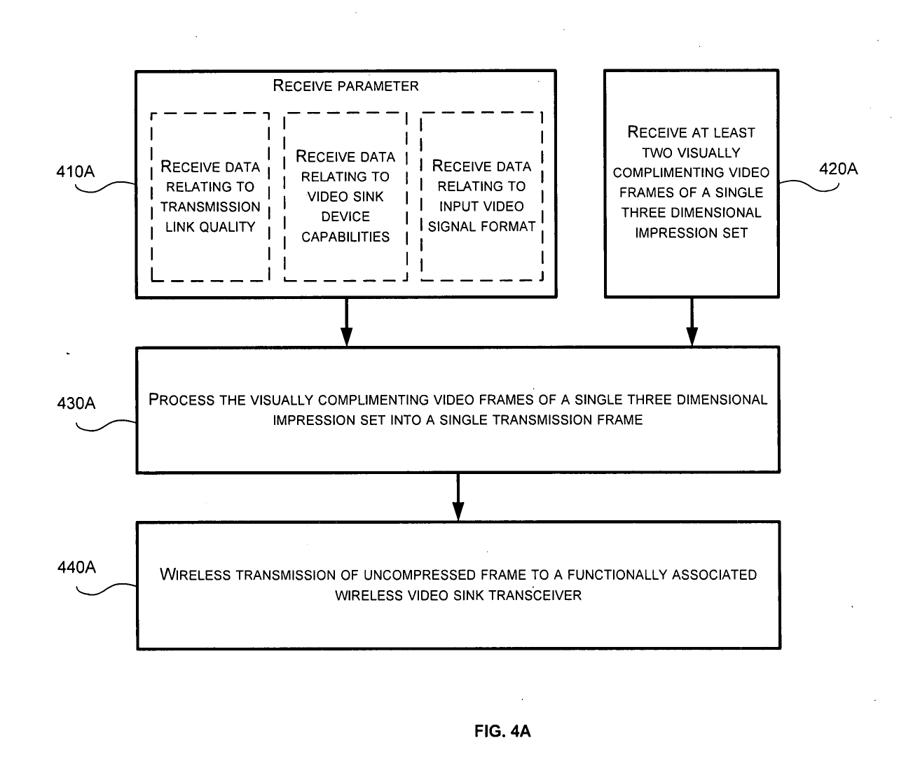

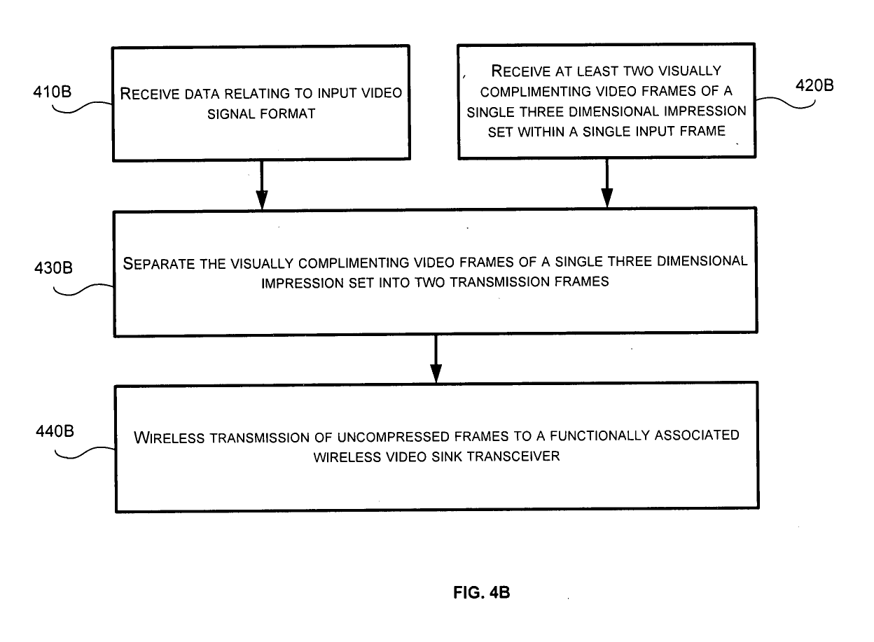

Now turning to FIG. 4A, there is shown a schematic diagram including the steps of an exemplary method by which source transceiver may process complimenting video frames with associated parameters according to some embodiments of the present invention.

According to some embodiments of the present invention, a video transmitter such as video source transceiver 220A may receive (420A) at least two visually complimenting video frames of a single three dimensional impression set. According to further embodiments of the present invention, video source transceiver 220A may receive (410A) parameters relating to a wireless transmission of video frames including data relating to transmission link quality, data relating to video sink device capabilities and/or data relating to input video signal format. Video source transceiver 220A may utilize these parameters for processing the video frames (430A) into a single transmission frame. According to further embodiments of the present invention, video source transceiver 220A may wirelessly transmit (440A) the uncompressed transmission frame to a functionally associated wireless video sink transceiver, optionally employing an orthogonal frequency-division multiplexing (OFDM) transmitter.

Now turning to FIG. 4B, there is shown a schematic diagram including the steps of an exemplary method by which source transceiver may process complimenting video frames with associated parameters according to some embodiments of the present invention.

According to some embodiments of the present invention, a video transmitter such as video source transceiver 220B may receive (420B) at least two visually complimenting video frames of a single three dimensional impression set within a single input frame. According to further embodiments of the present invention, video source transceiver 220B may receive (410B) data relating to input video signal format. Video source transceiver 220B may separate the visually complimenting video frames of a single three dimensional impression set (430B) into two transmission frames. According to further embodiments of the present invention, video source transceiver 220B may wirelessly transmit (440B) the uncompressed transmission frames to a functionally associated wireless video sink transceiver, optionally employing an orthogonal frequency-division multiplexing (OFDM) transmitter.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A transmitter comprising:
video signal/stream processing logic adapted to combine data from at least two visually complimenting video frames of a single three dimensional impression set into a single video transmission frame.

2. The transmitter according to claim 1, wherein said video signal/stream processing logic is further adapted to determine a first format of a received video signal/stream including at least two visually complimenting frames of a single three dimensional impression set.

3. The transmitter according to claim 2, wherein said video signal/stream processing logic is further adapted to select a second format for a transmission frame, wherein selection is at least partially based on a parameter selected from the group consisting of transmission link quality, capabilities of a video sink device, capabilities of a video sink-side transceiver, and format of the input video signal/stream.

4. The transmitter according to claim 3, wherein the second format for a transmission frame is selected from the group consisting of a horizontal stripe partition, a checkerboard arrangement, a vertical stripe partition, and a division of the frames.

5. The transmitter according to claim 1, further adapted to transmit the single video transmission frame to a functionally associated receiver.

6. The transmitter according to claim 1; further adapted to be an OFDM transmitter.

7. A transmitter comprising:
video signal/stream processing logic adapted to determine a first format of a received video signal/stream including at least two visually complimenting frames of a single three dimensional impression set, and further adapted to select a second format for a transmission frame, wherein selection is at least partially based on a parameter selected from the group consisting of transmission link quality, capabilities of a video sink device, capabilities of a video sink-side transceiver, and format of the input video signal/stream.

8. The transmitter according to claim 7, wherein the second format for a transmission frame is selected from the group consisting of a horizontal stripe partition, a checkerboard arrangement, a vertical stripe partition, and a division of the frames.

9. The transmitter according to claim 8, wherein said video signal/stream processing logic is further adapted to combine data from at least two visually complimenting video frames of a single three dimensional impression set into a single video transmission frame.

10. The transmitter according to claim 7, further adapted to transmit the single video transmission frame to a functionally associated receiver.

11. The transmitter according to claim 7, further adapted to be an OFDM transmitter.

12. A transmitter comprising:
video signal/stream processing logic adapted to separate data from at least two visually complimenting video frames of a single three dimensional impression set into two video transmission frames.

13. The transmitter according to claim 12, further comprising a format resolver adapted to determine a format of the three dimensional impression set.

14. The transmitter according to claim 13, wherein the determined format of the three dimensional impression set is from the group consisting of a horizontal stripe partition, a checkerboard arrangement, a vertical stripe partition, and a division of the frames.

15. The transmitter according to claim 13, wherein the format resolver is further adapted to determine a location of an interlude situated between the visually complimenting video frames.

16. The transmitter according to claim 15, further adapted to remove and/or relocate the interlude.

17. The transmitter according to claim 12, further adapted to transmit the two video transmission frames to a functionally associated receiver.

18. The transmitter according to claim 12, further adapted to be an OFDM transmitter.
